(19) United States
(12) Patent Application Publication
(10) Pub. No.: US 2025/0264426 A1
(43) Pub. Date: Aug. 21, 2025

(54) SENSOR

(71) Applicant: KABUSHIKI KAISHA TOSHIBA, Tokyo (JP)

(72) Inventors: Yoshihiko KURUI, Chigasaki Kanagawa (JP); Yosuke AKIMOTO, Yokohama Kanagawa (JP)

(73) Assignee: KABUSHIKI KAISHA TOSHIBA, Tokyo (JP)

(21) Appl. No.: 19/033,605

(22) Filed: Jan. 22, 2025

(30) Foreign Application Priority Data
Feb. 19, 2024 (JP) 2024-022503

(51) Int. Cl. G01N 27/04; G01N 27/12

(52) U.S. Cl. CPC G01N 27/046; G01N 27/122

(57) ABSTRACT

According to one embodiment, a sensor includes a base, a first detection section, a first conductive layer, and a first conductive layer terminal. The base includes a first base region including a first intermediate region. The first conductive layer is fixed to the base. The first conductive layer includes a first conductive region and a first other conductive region. The first conductive layer terminal is electrically connected to the first conductive layer. The first detection section includes a first fixed portion fixed to the first base region, and a first element supported by the first fixed portion. The first element includes a first resistance member and a first conductive member. A first gap is provided between the first intermediate region and the first element in the first direction.

### CROSS-REFERENCE TO RELATED APPLICATIONS

This application is based upon and claims the benefit of priority from Japanese Patent Application No. 2024-022503, filed on Feb. 19, 2024; the entire contents of which are incorporated herein by reference.

### FIELD

Embodiments described herein relate generally to a sensor.

### BACKGROUND

For example, there are sensors using MEMS (Micro Electro Mechanical Systems) elements. Stable detection is desired in sensors.

### BRIEF DESCRIPTION OF THE DRAWINGS

FIGS. 1A to 1C are schematic cross-sectional views illustrating a sensor according to a first embodiment;

FIGS. 2A and 2B are schematic plan views illustrating the sensor according to the first embodiment;

FIG. 3 is a schematic plan view illustrating the sensor according to the first embodiment;

FIGS. 4A to 4C are schematic cross-sectional views illustrating a sensor according to the first embodiment;

FIGS. 5A to 5C are schematic cross-sectional views illustrating a sensor according to the first embodiment;

FIGS. 6A to 6C are schematic cross-sectional views illustrating a sensor according to the first embodiment;

FIGS. 7A to 7C are schematic cross-sectional views illustrating a sensor according to the first embodiment;

FIGS. 8A to 8C are schematic cross-sectional views illustrating a sensor according to the first embodiment; and

FIGS. 9A to 9C are schematic cross-sectional views illustrating a sensor according to the first embodiment.

### DETAILED DESCRIPTION

According to one embodiment, a sensor includes a base, a first detection section, a first conductive layer, and a first conductive layer terminal. The base includes a first base region including a first intermediate region. The first conductive layer is fixed to the base. The first conductive layer includes a first conductive region and a first other conductive region. The first conductive layer terminal is electrically connected to the first conductive layer. The first detection section includes a first fixed portion fixed to the first base region, and a first element supported by the first fixed portion. The first element includes a first resistance member and a first conductive member. A position of the first intermediate region in a second direction crossing a first direction from the first base region to the first fixed portion is between a position of the first conductive region in the second direction and a position of the first other conductive region in the second direction. A first gap is provided between the first intermediate region and the first element in the first direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

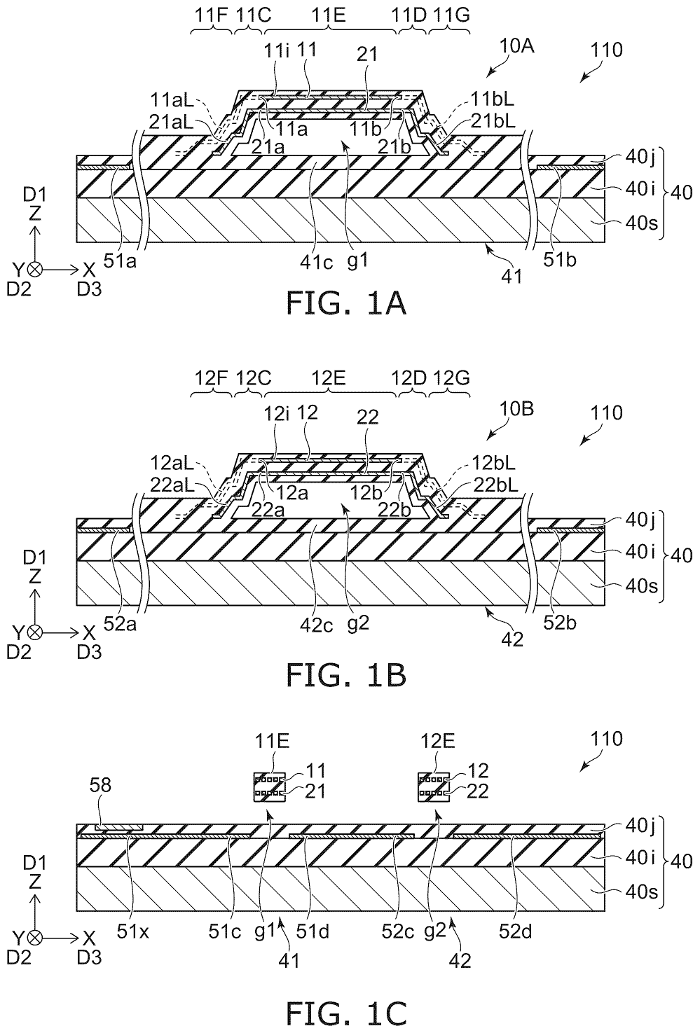

FIGS. 1A to 1C are schematic cross-sectional views illustrating a sensor according to the first embodiment.

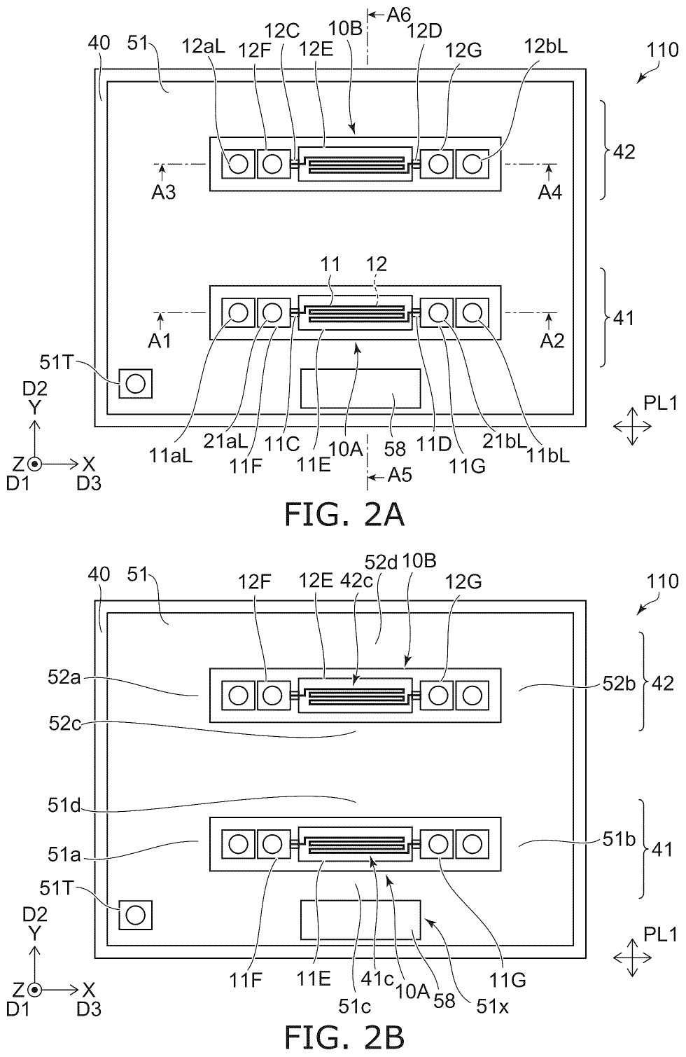

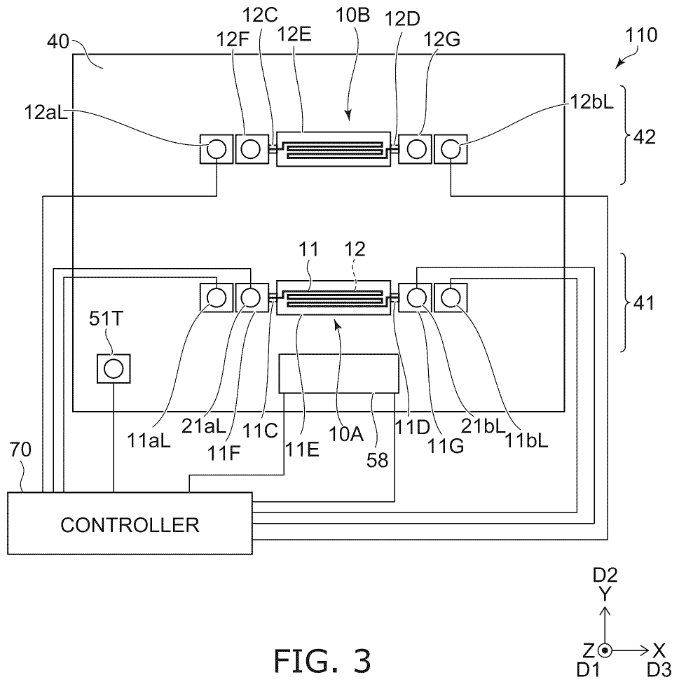

FIGS. 2A, 2B, and 3 are schematic plan views illustrating the sensor according to the first embodiment.

FIG. 1A is a cross-sectional view taken along the line A1-A2 in FIG. 2A. FIG. 1B is a sectional view taken along the line A3-A4 in FIG. 2A. FIG. 1C is a sectional view taken along the line A5-A6 in FIG. 2A.

As shown in these figures, a sensor 110 according to the embodiment includes a base 40, a first detection section 10A, and a first conductive layer 51. The sensor 110 may further include a first conductive layer terminal 51T. As described later, the sensor 110 may further include a second detection section 10B and the like.

The base 40 includes a first base region 41. The first base region 41 includes a first intermediate region 41c. The base 40 may include, for example, a substrate 40s, a first insulating layer 40i, and a second insulating layer 40j. The substrate 40s may be, for example, a semiconductor substrate. The substrate 40s may include, for example, a silicon substrate. The first insulating layer 40i is provided on the substrate 40s. The second insulating layer 40j is provided on the first insulating layer 40i. The first insulating layer 40i may include silicon oxide, for example. The second insulating layer 40j may include silicon nitride, for example.

The first conductive layer 51 is fixed to the base 40. In this example, the first conductive layer 51 is provided between the first insulating layer 40i and the second insulating layer 40j. The first conductive layer 51 includes a first conductive region 51c and a first other conductive region 51d. The first conductive layer terminal 51T is electrically connected to the first conductive layer 51.

The first detection section 10A includes a first fixed portion 11F fixed to the first base region 41 and a first element 11E supported by the first fixed portion 11F. The first element 11E includes a first resistance member 11 and a first conductive member 21.

A first direction D1 from the first base region 41 to the first fixed portion 11F is defined as a Z-axis direction. One direction perpendicular to the Z-axis direction is defined as a Y-axis direction. A direction perpendicular to the Z-axis direction and the Y-axis direction is defined as an X-axis direction.

As shown in FIG. 2B, a position of the first intermediate region 41c in a second direction D2 crossing the first direction D1 is between a position of the first conductive region 51c in the second direction D2 and a position of the first other conductive region 51d in the second direction D2. The second direction D2 may be, for example, the Y-axis direction.

As shown in FIG. 1A, a first gap g1 is provided between the first intermediate region 41c and the first element 11E in the first direction D1.

As shown in FIG. 1A, the first resistance member 11 includes a first resistance portion 11a and a first other resistance portion 11b. The first conductive member 21 includes a first conductive portion 21a and a first other conductive portion 21b.

In the embodiment, a first power is supplied between the first conductive portion 21a and the first other conductive portion 21b. A first electrical resistance between the first resistance portion 11a and the first other resistance portion 11b is detected. As shown in FIG. 3, a controller 70 may be provided in the sensor 110. The controller 70 may be configured to supply the first power. The controller 70 may be configured to detect the first electrical resistance.

The first electrical resistance changes depending on a detection target existing in a space around the first element 11E. For example, by supplying the first power to the first conductive member 21 as described above, the temperature of the first element 11E increases. The first power may be supplied in a pulsed manner, for example. After the temperature of the first element 11E increases due to the first electric power, the temperature of the first element 11E decreases toward the original temperature. The heat of the first element 11E is radiated through the detection target existing around the first element 11E. Therefore, the temperature of the first element 11E depends on the state of the detection target existing around the first element 11E. The first electrical resistance of the first element 11E changes depending on the temperature of the first element 11E. By detecting the first electrical resistance, the state of the detection target can be detected. The detection target is, for example, gas. For example, the state of the detection target includes the type and concentration of the detection target (gas).

In the embodiment, the first conductive layer 51 is provided. The first conductive layer 51 is provided on the base 40 having a large heat capacity. The first conductive layer 51 functions as a heat homogenization layer. Thereby, for example, the temperature change characteristics of the first element 11E can be made less susceptible to the influence of the ambient temperature. For example, stable detection becomes possible. For example, highly accurate detection becomes possible. According to the embodiment, a sensor capable of highly accurate detection can be provided.

As described above, the first conductive layer terminal 51T electrically connected to the first conductive layer 51 is provided. The potential of the first conductive layer terminal 51T may be fixed. The potential of the first conductive layer terminal 51T may be, for example, a ground potential. The first conductive layer 51 functions, for example, as a ground layer. Thereby, potential is stabilized, noise is suppressed, and higher accuracy is obtained.

For example, the potential of the first resistance portion 11a may be set to a first potential (ground ionization) of the first conductive layer terminal 51T. The potential of the first conductive portion 21a may be set to the first potential (ground potential). The first conductive layer terminal 51T may be electrically connected to the controller 70. The first other resistance portion 11b may be electrically connected to the controller 70. The first other conductive portion 21b may be electrically connected to the controller 70.

In the embodiment, a first conductive region area of the first conductive region 51c in a first plane PL1 crossing the first direction D1 is preferably larger than a first element area of the first element 11E in the first plane PL1. The first plane PL1 is, for example, an X-Y plane. A first other conductive region area of the first other conductive region 51d in the first plane PL1 is preferably larger than the first element area of the first element 11E in the first plane PL1. When these conductive regions are large, for example, thermal uniformity can be improved. Thereby, more stable detection can be performed.

As shown in FIGS. 1C, 2A, and 2C, the sensor 110 may further include a first temperature detection element 58. The controller 70 may be configured to output a value obtained by correcting the first electrical resistance based on a value detected by the first temperature detection element 58. Thereby, detection results with higher accuracy can be obtained.

As shown in FIG. 1C and FIG. 2B, the first conductive layer 51 may further include a first temperature detection region 51x. The first temperature detection region 51x may be continuous with the first conductive region 51c. The boundaries between these conductive regions may be clear or unclear. The first temperature detection region 51x may overlap the first temperature detection element 58 in the first direction D1. The temperature in the first temperature detection element 58 becomes more stable.

As shown in FIG. 2B, the first conductive layer 51 may further include a first fixed portion region 51a being continuous with the first conductive region 51c. A position of the first fixed portion 11F in a third direction D3 is between a position of the first fixed portion region 51a in the third direction D3 and a position of the first intermediate region 41c in the third direction D3. The third direction D3 crosses a plane including the first direction D1 and the second direction D2. The third direction D3 may be, for example, the X-axis direction. By providing the first fixed portion region 51a, a more uniform temperature distribution is obtained.

As shown in FIGS. 1A and 2B, the first detection section 10A may further include a first other fixed portion 11G fixed to the first base region 41. The first element 11E is further supported by the first other fixed portion 11G. The first conductive layer 51 further includes a first other fixed portion region 51b being continuous with the first conductive region 51c. A position of the first other fixed portion 11G in the third direction D3 is between a position of the first intermediate region 41c in the third direction D3 and a position of the first other fixed portion region 51b in the third direction D3. By providing the first other fixed portion region 51b, a more uniform temperature distribution can be obtained.

As shown in FIG. 1B and FIG. 2B, the sensor 110 may further include a second detection section 10B. The base 40 may further include a second base region 42 including a second intermediate region 42c.

The second detection section 10B includes a second fixed portion 12F fixed to the second base region 42 and a second element 12E supported by the second fixed portion 12F. The second element 12E includes the second resistance member 12.

The first conductive layer 51 further includes a second conductive region 52c and a second other conductive region 52d being continuous with the first conductive region 51c and the first other conductive region 51d. A position of the second intermediate region 42c in the second direction D2 is between a position of the second conductive region 52c in the second direction D2 and a position of the second other conductive region 52d in the second direction D2. In the first direction D1, a second gap g2 is provided between the second intermediate region 42c and the second element 12E.

The controller 70 may be configured to output a value corresponding to a difference between the second electrical resistance of the second resistance member 12 and the first electrical resistance of the first resistance member 11. The second element 12E may function as a reference element, for example. As described above, the temperature of the first resistance member 11 changes by supplying the first current to the first conductive member 21 of the first element 11E. On the other hand, no power is supplied to the second element 12E, and the temperature of the second resistance member 12 does not substantially change. By detecting the difference between the first electrical resistance and the second electrical resistance, for example, a detection result that suppresses the influence of ambient temperature can be obtained. For example, compensated results are obtained.

In the embodiment, the controller 70 may be configured to output a value obtained by correcting the difference between the second electrical resistance of the second resistance member 12 and the first electrical resistance of the first resistance member 11 by the value detected by the first temperature detection element 58. As a result, a detection result with higher accuracy can be obtained.

In the embodiment, the first conductive layer 51 is provided with a second conductive region 52c and a second other conductive region 52d. Thereby, for example, heat uniformity can be improved. More stable detection becomes possible.

In the embodiment, the second element 12E may include a second conductive member 22. The second conductive member 22 does not need to be supplied with power. The second conductive member 22 is, for example, a dummy conductive member. By providing the second conductive member 22, for example, the thermal characteristics (e.g., heat capacity) of the second element 12E become the same as the thermal characteristics (e.g., heat capacity) of the first element 11E. Higher accurate compensation is obtained.

The first conductive layer 51 may further include a second fixed portion region 52a being continuous with the second conductive region 52c. A position of the second fixed portion 12F in the third direction D3 is between a position of the second fixed portion region 52a in the third direction D3 and a position of the second intermediate region 42c in the third direction D3. The third direction D3 crosses a plane including the first direction D1 and the second direction D2. The second fixed portion region 52a can further improve heat uniformity.

The second detection section 10B may further include a second other fixed portion 12G fixed to the second base region 42. The second element 12E is further supported by the second other fixed portion 12G. The first conductive layer 51 may further include a second other fixed portion region 52b being continuous with the second conductive region 52c. A position of the second other fixed portion 12G in the third direction D3 is between a position of the second intermediate region 42c in the third direction D3 and a position of the second other fixed portion region 52b in the third direction D3. The heat uniformity can be further improved by the second other fixed portion region 52b.

As shown in FIG. 2A, the first detection section 10A may further include a first connecting portion 11C. The first connecting portion 11C is supported by the first fixed portion 11F. The first connecting portion 11C supports the first element 11E. A width of the first connecting portion 11C in the third direction D3 is smaller than a width of the first element 11E in the third direction D3. A part of the first gap g1 is provided between the first base region 41 and the first connecting portion 11C.

The first detection section 10A may further include a first other connecting portion 11D. The first other connecting portion 11D is supported by the first other fixed portion 11G. The first other connecting portion 11D supports the first element 11E. A width of the first other connecting portion 11D in the third direction D3 is smaller than the width of the first element 11E in the third direction D3. A part of the first gap g1 is provided between the first base region 41 and the first other connecting portion 11D.

As shown in FIG. 1A, for example, a first resistance wiring 11aL electrically connected to the first resistance portion 11a may pass through the first connecting portion 11C and the first fixed portion 11F. For example, a first conductive wiring 21aL electrically connected to the first conductive portion 21a may pass through the first connecting portion 11C and the first fixed portion 11F.

As shown in FIG. 1A, for example, a first other resistance wiring 11bL electrically connected to the first other resistance portion 11b may pass through the first other connecting portion 11D and the first other fixed portion 11G. For example, a first other conductive wiring 21bL electrically connected to the first other conductive portion 21b may pass through the first other connecting portion 11D and the first other fixed portion 11G.

One of the first resistance wiring 11aL and the first other resistance wiring 11bL may be set to the first potential. One of the first conductive wiring 21aL and the first other conductive wiring 21bL may be set to the first potential.

As shown in FIG. 2A, the second detection section 10B may further include a second connecting portion 12C. The second connecting portion 12C is supported by the second fixed portion 12F. The second connecting portion 12C supports the second element 12E. A width of the second connecting portion 12C in the third direction D3 is smaller than a width of the second element 12E in the third direction D3. A part of the second gap g2 is provided between the second base region 42 and the second connecting portion 12C.

The second detection section 10B may further include a second other connecting portion 12D. The second other connecting portion 12D is supported by the second other fixed portion 12G. The second other connecting portion 12D supports the second element 12E. A width of the second other connecting portion 12D in the third direction D3 is smaller than the width of the second element 12E in the third direction D3. A part of the second gap g2 is provided between the second base region 42 and the second other connecting portion 12D.

As shown in FIG. 1B, the second resistance member 12 includes a second resistance portion 12a and a second other resistance portion 12b. The second conductive member 22 includes a second conductive portion 22a and a second other conductive portion 22b.

As shown in FIG. 1B, for example, a second resistance wiring 12aL electrically connected to the second resistance portion 12a may pass through the second connecting portion 12C and the second fixed portion 12F. For example, a second conductive wiring 22aL electrically connected to the second conductive portion 22a may pass through the second connecting portion 12C and the second fixed portion 12F.

As shown in FIG. 1B, for example, a second other resistance wiring 12bL electrically connected to the second other resistance portion 12b may pass through the second other connecting portion 12D and the second other fixed portion 12G. For example, the second other conductive wiring 22bL electrically connected to the second other conductive portion 22b may pass through the second other connecting portion 12D and the second other fixed portion 12G.

One of the second resistance wiring 12aL and the second other resistance wiring 12bL may be set to the first potential. One of the second conductive wiring 22aL and the second other conductive wiring 22bL may be set to the first potential. The controller 70 does not need to supply the second conductive member 22 with an electric power.

As shown in FIGS. 1A and 1B, the first element 11E may include a first insulating member 11i. The first insulating member 11i is provided around the first resistance member 11 and the first conductive member 21. The second element 12E may include a second insulating member 12i. The second insulating member 12i is provided around the second resistance member 12 and the second conductive member 22.

At least one of the first insulating member 11i or the second insulating member 12i may include, for example, silicon nitride. As described later, at least one of the first insulating member 11i or the second insulating member 12i may include a metal oxide or the like. The first insulating member 11i may be provided at the first connecting portion 11C and the first other connecting portion 11D. The second insulating member 12i may be provided at the second connecting portion 12C and the second other connecting portion 12D.

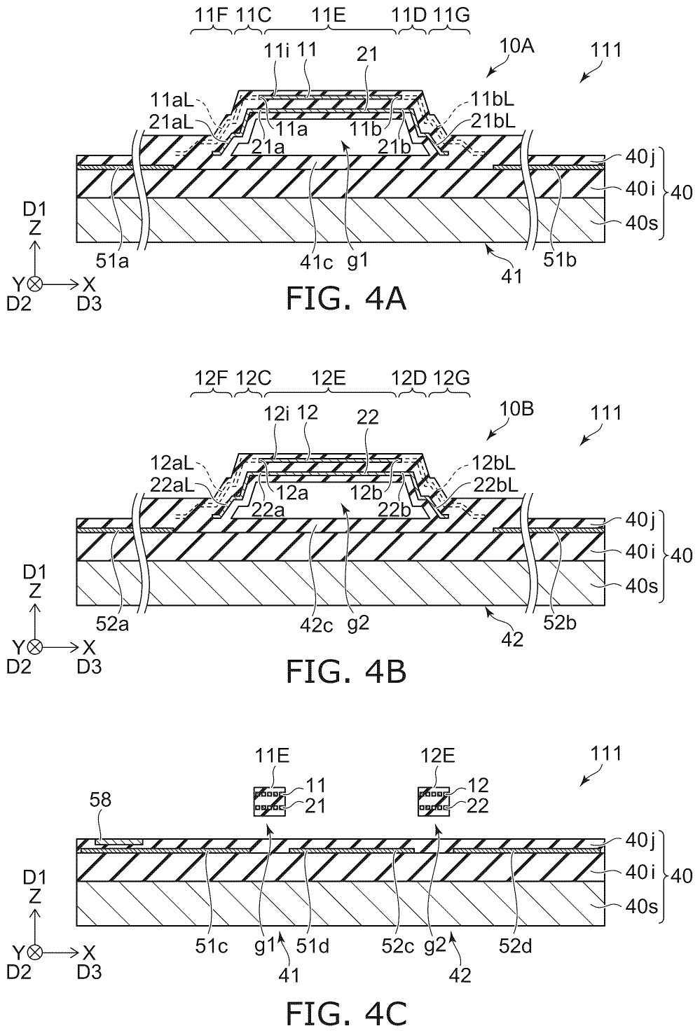

FIGS. 4A to 4C are schematic cross-sectional views illustrating a sensor according to the first embodiment.

As shown in FIGS. 4A to 4C, in a sensor 111 according to the embodiment, a part of the first conductive layer 51 overlaps the first fixed portion 11F in the first direction D1. In this example, a part of the first conductive layer 51 overlaps the first other fixed portion 11G in the first direction D1. A part of the first conductive layer 51 overlaps the second fixed portion 12F in the first direction D1. In this example, a part of the first conductive layer 51 overlaps the second other fixed portion 12G in the first direction D1. The configuration of the sensor 111 except for these may be the same as the configuration of the sensor 110. The sensor 111 can also provide a sensor capable of highly accurate detection.

A part of the first conductive layer 51 may overlap the first connecting portion 11C in the first direction D1. A part of the first conductive layer 51 may overlap the first other connecting portion 11D in the first direction D1. A part of the first conductive layer 51 may overlap the second connecting portion 12C in the first direction D1. A part of the first conductive layer 51 may overlap the second other connecting portion 12D in the first direction D1.

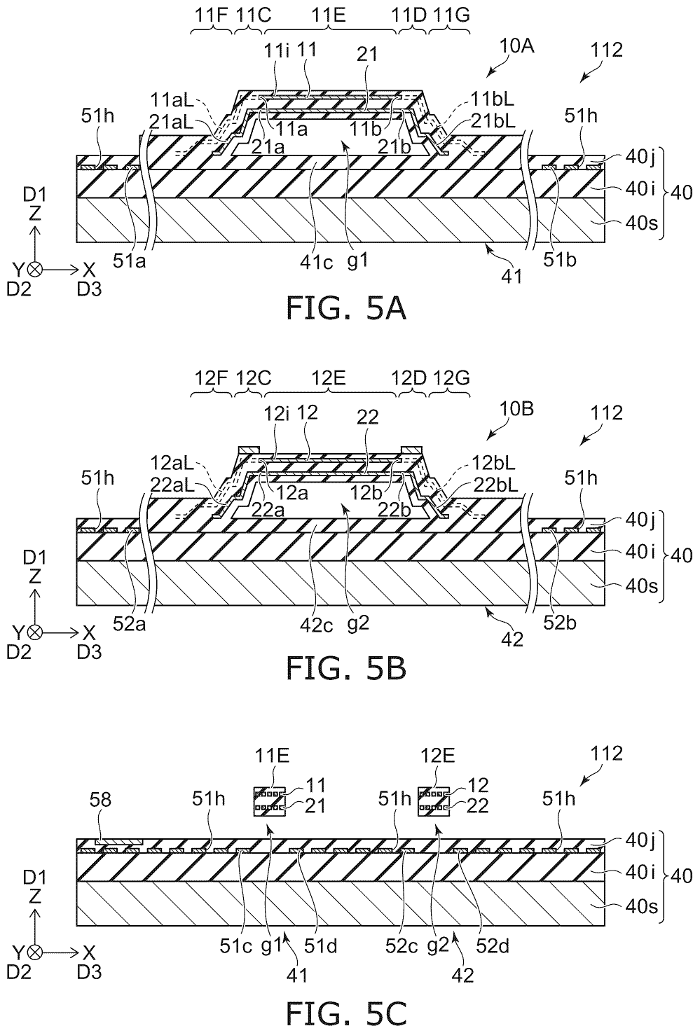

FIGS. 5A to 5C are schematic cross-sectional views illustrating a sensor according to the first embodiment.

As shown in FIGS. 5A to 5C, in a sensor 112 according to the embodiment, the first conductive layer 51 includes holes 51h. The configuration of the sensor 112 except for this may be the same as the configuration of the sensor 110, or the configuration of the sensor 111. Thermal conductivity is appropriately controlled by the holes 51h. The sensor 112 can also provide a sensor capable of highly accurate detection.

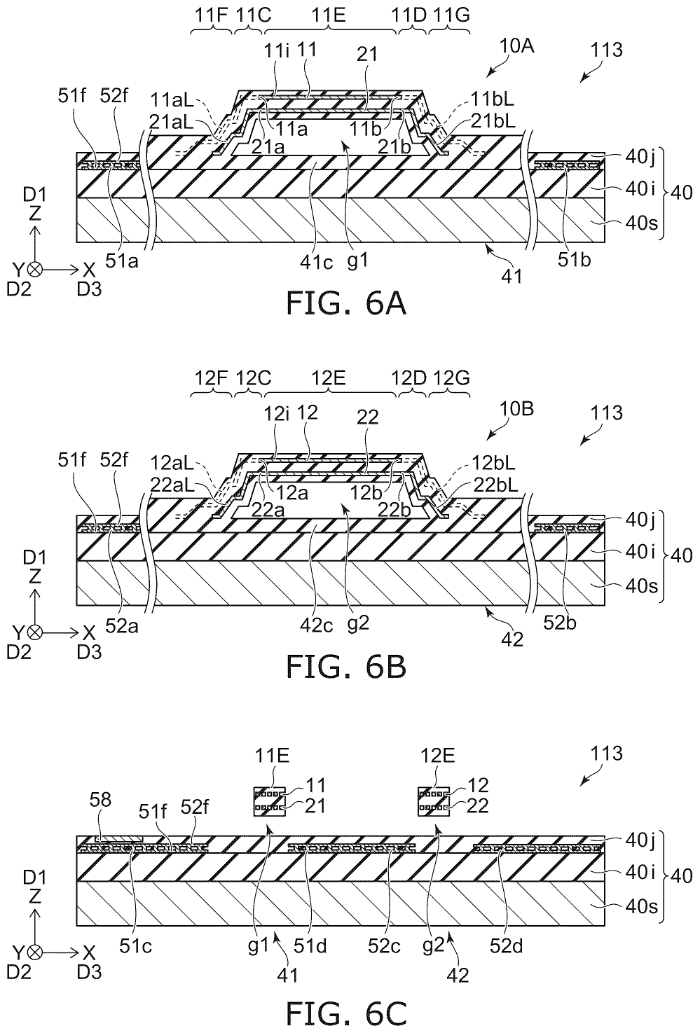

FIGS. 6A to 6C are schematic cross-sectional views illustrating a sensor according to the first embodiment.

As shown in FIGS. 6A to 6C, in a sensor 113 according to the embodiment, the first conductive layer 51 includes a first conductive film 51f and a second conductive film 52f. At least a part of the second conductive film 52f overlaps the first conductive film 51f in the first direction D1. The second conductive film 52f is electrically connected to the first conductive film 51f. A part of the base 40 may be provided between the first conductive film 51f and the second conductive film 52f. In this example, a part of the second insulating layer 40j is provided between the first conductive film 51f and the second conductive film 52f. The configuration of the sensor 113 except for these may be the same as the configuration of the sensors 110 to 112. Low electrical resistance can be obtained by the first conductive film 51f and the second conductive film 52f. High uniformity of heat is obtained.

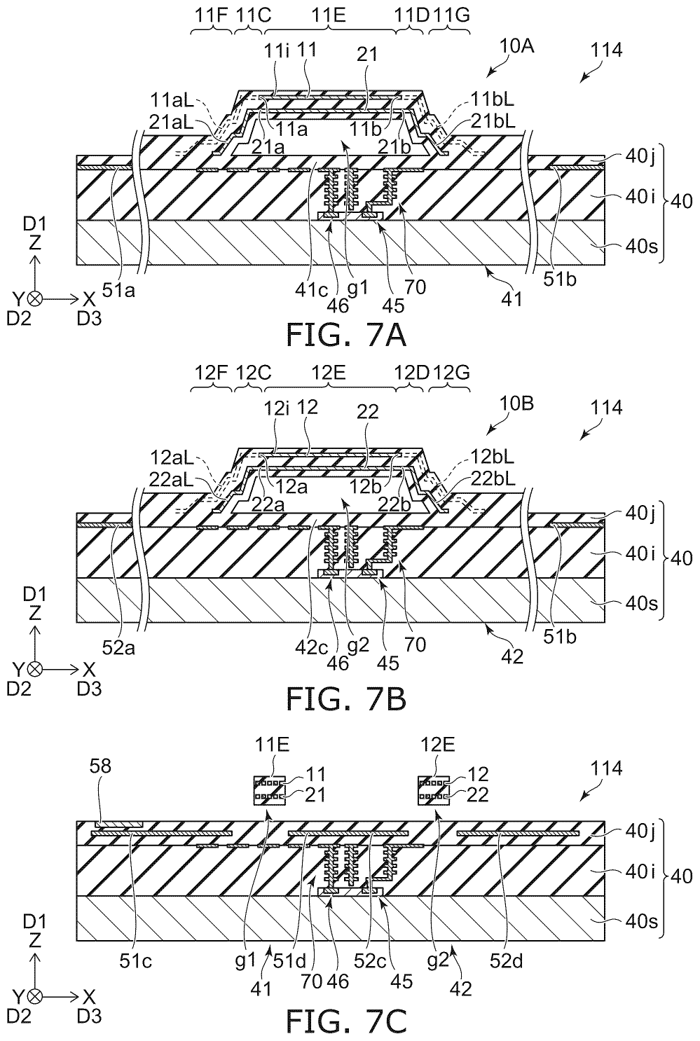

FIGS. 7A to 7C are schematic cross-sectional views illustrating a sensor according to the first embodiment.

As shown in FIGS. 7A to 7C, in a sensor 114 according to the embodiment, the controller 70 includes a control element 45. The control element 45 may be, for example, a switching element such as a transistor. The control element 45 may overlap at least one of the first element 11E and the first conductive layer 51 in the first direction D1. In this example, the control element 45 overlaps the first element 11E in the first direction D1. The control element 45 may overlap the second element 12E in the first direction D1. It becomes easy to obtain a small sensor. Noise is suppressed. The configuration of the sensor 114 except for this may be the same as the configuration of the sensors 110 to 113. In this example, the control element 45 includes a CMOS 46 (Complementary Metal Oxide Semiconductor).

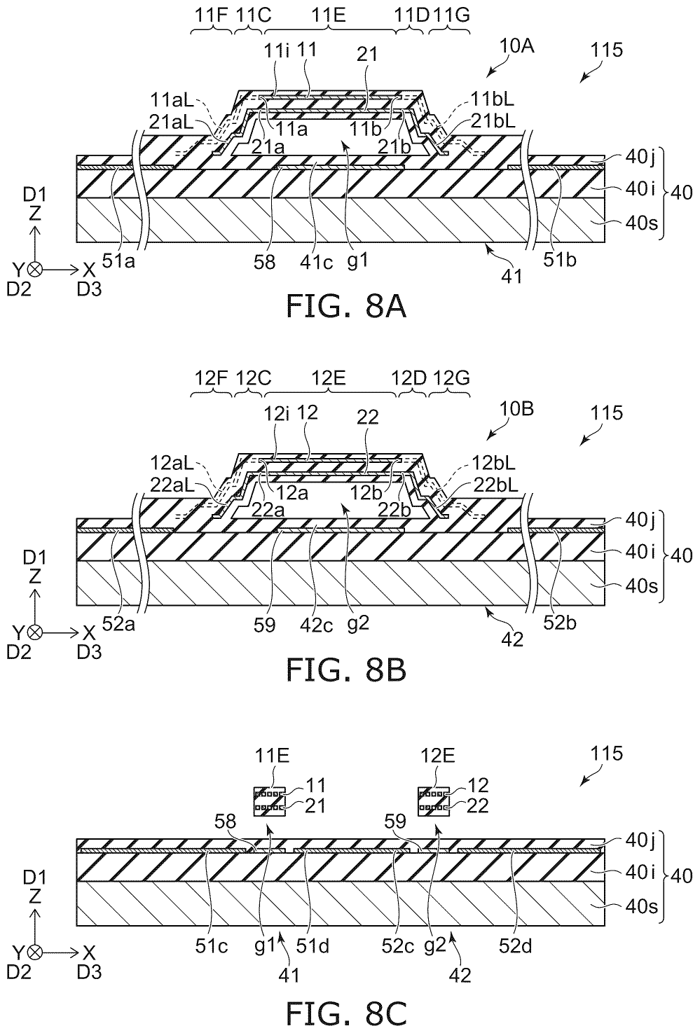

FIGS. 8A to 8C are schematic cross-sectional views illustrating a sensor according to the first embodiment.

As shown in FIGS. 8A and 8C, in a sensor 115 according to the embodiment, at least a part of the first temperature detection element 58 overlaps the first element 11E in the first direction D1. The configuration of sensor 115 except for this may be the same as the configuration of sensors 110 to 114. By the first temperature detection element 58 overlapping the first element 11E, the temperature of the first element 11E can be detected with higher accuracy.

As shown in FIG. 8B, a second temperature detection element 59 may be provided in the sensor 115. At least a part of the second temperature detection element 59 may overlap the second element 12E in the first direction D1. By the second temperature detection element 59 overlapping the second element 12E, the temperature of the second element 12E can be detected with higher accuracy. The controller 70 may correct the detected value based on the value detected by the second temperature detection element 59.

### Second Embodiment

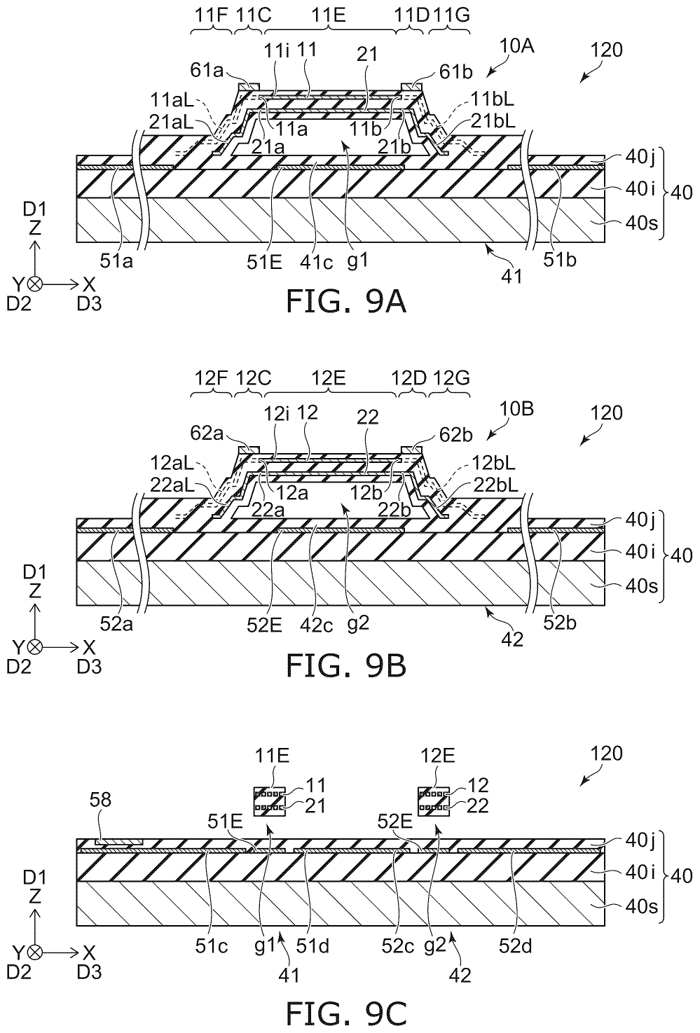

FIGS. 9A to 9C are schematic cross-sectional views illustrating a sensor according to the first embodiment.

FIG. 9A is a cross-sectional view corresponding to the line A1-A2 in FIG. 2A. FIG. 9B is a sectional view corresponding to the line A3-A4 in FIG. 2A. FIG. 9C is a cross-sectional view corresponding to the line A5-A6 in FIG. 2A.

As shown in FIG. 9A, in a sensor 120 according to the embodiment, the first detection section 10A includes a first fixed electrode 51E. The configuration of sensor 120 except for this may be the same as the configuration of sensors 110 to 115.

In the sensor 120, the first fixed electrode 51E is fixed to the first base region 41. A first gap g1 is provided between the first fixed electrode 51E and the first conductive member 21. In the sensor 120, a distance between the first fixed electrode 51E and the first conductive member 21 changes depending on the state of the detection target existing around the first element 11E. The detection target can be detected by detecting the first capacitance between the first fixed electrode 51E and the first conductive member 21 according to the change in distance.

In this example, the first insulating member 11i includes a first layer 61a at the first connecting portion 11C. The volume of the first layer 61a changes depending on the detection target (for example, hydrogen, etc.) that exists around the first element 11E. Stress is applied to the first connecting portion 11C due to the change in the volume of the first layer 61a. Due to the stress, the distance between the first fixed electrode 51E and the first conductive member 21 changes.

For example, the first insulating member 11i includes a first other layer 61b in the first other connecting portion 11D. The volume of the first other layer 61b changes depending on the detection target existing around the first element 11E. Due to the change in volume of the first other layer 61b, stress is applied to the first other connecting portion 11D. Due to the stress, the distance between the first fixed electrode 51E and the first conductive member 21 changes.

In the sensor 120, the second element 12E includes a second conductive member 22. In the sensor 120, the second detection section 10B includes a second fixed electrode 52E. The second fixed electrode 52E is fixed to the second base region 42. The second gap g2 is provided between the second fixed electrode 52E and the second conductive member 22. The distance between the second fixed electrode 52E and the second conductive member 22 changes depending on the state of the detection target existing around the second element 12E. The detection target can be detected by detecting the second capacitance between the second fixed electrode 52E and the second conductive member 22 in accordance with the change in distance.

In this example, the second insulating member 12i includes a second layer 62a at the second connecting portion 12C. The volume of the second layer 62a changes depending on the detection target (for example, hydrogen, etc.) that exists around the second element 12E. Stress is applied to the second connecting portion 12C due to the change in the volume of the second layer 62a. Due to the stress, the distance between the second fixed electrode 52E and the second conductive member 22 changes.

For example, the second insulating member 12i includes a second other layer 62b in the second other connecting portion 12D. The volume of the second other layer 62b changes depending on the detection target existing around the second element 12E. Due to the change in the volume of the second other layer 62b, stress is applied to the second other connecting portion 12D. Due to the stress, the distance between the second fixed electrode 52E and the second conductive member 22 changes.

At least one of the first layer 61a, the first other layer 61b, the second layer 62a, or the second other layer 62b includes, for example, a metal oxide. At least one of the first layer 61a, the first other layer 61b, the second layer 62a, or the second other layer 62b includes, for example, oxygen and at least one metal selected from the group consisting of Pt, Pd, and Ti.

In the second embodiment, the first conductive member 21 and the second conductive member 22 function as fixed electrodes, for example. In the second embodiment, the first resistance member 11 and the second resistance member 12 function as a heater, for example.

In the first embodiment and the second embodiment, the controller 70 may include, for example, at least one of a gas detection circuit, a temperature detection circuit, a heater voltage generation circuit, or a control circuit. The gas detection circuit may include an electrical resistance detection section or a capacitance detection section.

In the embodiment, at least one of the first resistance member 11 or the second resistance member 12 may include at least one selected from the group consisting of, for example, TiN, Ti, W, A1, Cu, AlCu, Si, and Pd. At least one of the first conductive member 21 or the second conductive member 22 may include, for example, at least one selected from the group consisting of TIN, Ti, W, A1, Cu, AlCu, Si, and Pd.

The embodiments may include the following Technical proposals:

### (Technical Proposal 1)

A sensor, comprising:
a base including a first base region including a first intermediate region;
a first detection section;
a first conductive layer fixed to the base, the first conductive layer including a first conductive region and a first other conductive region; and
a first conductive layer terminal electrically connected to the first conductive layer,
the first detection section including:
   a first fixed portion fixed to the first base region, and
   a first element supported by the first fixed portion,
the first element including a first resistance member and a first conductive member,
a position of the first intermediate region in a second direction crossing a first direction from the first base region to the first fixed portion being between a position of the first conductive region in the second direction and a position of the first other conductive region in the second direction, and
a first gap being provided between the first intermediate region and the first element in the first direction.

### (Technical Proposal 2)

The sensor according to Technical proposal 1, wherein
a first conductive region area of the first conductive region in a first plane crossing the first direction is larger than a first element area of the first element in the first plane.

### (Technical Proposal 3)

The sensor according to Technical proposal 1 or 2, wherein
the first resistance member includes a first resistance portion and a first other resistance portion,
the first conductive member includes a first conductive portion and a first other conductive portion,
a potential of the first resistance portion is set to a first potential of the first conductive layer terminal, and
a potential of the first conductive portion is fixed to the first potential.

### (Technical Proposal 4)

The sensor according to Technical proposal 3, wherein
a first power is supplied between the first conductive portion and the first other conductive portion, and
a first electrical resistance between the first resistance portion and the first other resistance portion is detected.

### (Technical Proposal 5)

The sensor according to Technical proposal 4, further comprising:
a controller,
the controller being configured to supply the first power, and
the controller being configured to detect the first electrical resistance.

### (Technical Proposal 6)

The sensor according to Technical proposal 5, wherein
the first electrical resistance is configured to change depending on a detection target existing in a space around the first element.

### (Technical Proposal 7)

The sensor according to Technical proposal 6, further comprising:
a first temperature detection element,
the controller being configured to output a value obtained by correcting the first electrical resistance based on a value detected by the first temperature detection element.

### (Technical Proposal 8)

The sensor according to Technical proposal 7, wherein
the first conductive layer further includes a first temperature detection region being continuous with the first conductive region, and
the first temperature detection region overlaps the first temperature detection element in the first direction.

### (Technical Proposal 9)

The sensor according to any one of Technical proposals 1-8, wherein
a part of the first conductive layer overlaps the first fixed portion in the first direction.

### (Technical Proposal 10)

The sensor according to any one of Technical proposals 1-9, wherein
the first conductive layer further includes a first fixed portion region being continuous with the first conductive region,
a position of the first fixed portion in a third direction is between a position of the first fixed portion region in the third direction and a position of the first intermediate region in the third direction, and
the third direction crosses a plane including the first direction and the second direction.

### (Technical Proposal 11)

The sensor according to Technical proposal 10, wherein
the first detection section further includes a first other fixed portion fixed to the first base region,
the first element is further supported by the first other fixed portion,
the first conductive layer further includes a first other fixed portion region being continuous with the first conductive region, and
a position of the first other fixed portion in the third direction is between the position of the first intermediate region in the third direction and a position of the first other fixed portion region in the third direction.

### (Technical Proposal 12)

The sensor according to Technical proposal 7 or 8, further comprising:
a second detection section,
the base further including a second base region including a second intermediate region,
the second detection section including:
   a second fixed portion fixed to the second base region, and
   a second element supported by the second fixed portion,
the second element including a second resistance member,
the first conductive layer further including a second conductive region and a second other conductive region being continuous with the first conductive region and the first other conductive region,
a position of the second intermediate region in the second direction being between a position of the second conductive region in the second direction and a position of the second other conductive region in the second direction, and
a second gap being provided between the second intermediate region and the second element in the first direction.

### (Technical Proposal 13)

The sensor according to Technical proposal 12, wherein
the controller is configured to output a value obtained by correcting a difference between a second electrical resistance of the second resistance member and the first electrical resistance using a value detected by the first temperature detection element.

### (Technical Proposal 14)

The sensor according to Technical proposal 12 or 13, wherein
the first conductive layer further includes a second fixed portion region being continuous with the second conductive region,
a position of the second fixed portion in a third direction is between a position of the second fixed portion region in the third direction and a position of the second intermediate region in the third direction, and
the third direction crosses a plane including the first direction and the second direction.

### (Technical Proposal 15)

The sensor according to Technical proposal 14, wherein
the second detection section further includes a second other fixed portion fixed to the second base region,
the second element is further supported by the second other fixed portion,
the first conductive layer further includes a second fixed portion region being continuous with the second conductive region, and
the position of the second other fixed portion in the third direction is between the position of the second intermediate region in the third direction and a position of the second other fixed portion region in the third direction.

### (Technical Proposal 16)

The sensor according to any one of Technical proposals 12-15, wherein
the controller includes a control element, and
the control element overlaps at least one of the first element or the first conductive layer in the first direction.

### (Technical Proposal 17)

The sensor according to Technical proposal 16, wherein
the control element includes a CMOS (Complementary Metal Oxide Semiconductor).

### (Technical Proposal 18)

The sensor according to any one of Technical proposals 12-17, wherein
the second element further includes a second conductive member.

### (Technical Proposal 19)

The sensor according to any one of Technical proposals 1-18, wherein
the first conductive layer includes a first conductive film and a second conductive film,
at least a part of the second conductive film overlaps the first conductive film in the first direction,
the second conductive film is electrically connected to the first conductive film, and
a part of the base is provided between the first conductive film and the second conductive film.

### (Technical Proposal 20)

The sensor according to any one of Technical proposals 1-19, wherein
the first conductive layer includes a hole.

According to the embodiment, a sensor capable of highly accurate detection can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, detection sections, resistance members, conductive members, temperature detection elements, circuits, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base including a first base region including a first intermediate region;
a first detection section;
a first conductive layer fixed to the base, the first conductive layer including a first conductive region and a first other conductive region; and
a first conductive layer terminal electrically connected to the first conductive layer,
the first detection section including:
a first fixed portion fixed to the first base region, and
a first element supported by the first fixed portion,
the first element including a first resistance member and a first conductive member,
a position of the first intermediate region in a second direction crossing a first direction from the first base region to the first fixed portion being between a position of the first conductive region in the second direction and a position of the first other conductive region in the second direction, and
a first gap being provided between the first intermediate region and the first element in the first direction.

2. The sensor according to claim 1, wherein
a first conductive region area of the first conductive region in a first plane crossing the first direction is larger than a first element area of the first element in the first plane.

3. The sensor according to claim 1, wherein
the first resistance member includes a first resistance portion and a first other resistance portion,
the first conductive member includes a first conductive portion and a first other conductive portion,
a potential of the first resistance portion is set to a first potential of the first conductive layer terminal, and
a potential of the first conductive portion is fixed to the first potential.

4. The sensor according to claim 3, wherein
a first power is supplied between the first conductive portion and the first other conductive portion, and
a first electrical resistance between the first resistance portion and the first other resistance portion is detected.

5. The sensor according to claim 4, further comprising:
a controller,
the controller being configured to supply the first power, and
the controller being configured to detect the first electrical resistance.

6. The sensor according to claim 5, wherein
the first electrical resistance is configured to change depending on a detection target existing in a space around the first element.

7. The sensor according to claim 6, further comprising:
a first temperature detection element,
the controller being configured to output a value obtained by correcting the first electrical resistance based on a value detected by the first temperature detection element.

8. The sensor according to claim 7, wherein
the first conductive layer further includes a first temperature detection region being continuous with the first conductive region, and
the first temperature detection region overlaps the first temperature detection element in the first direction.

9. The sensor according to claim 1, wherein
a part of the first conductive layer overlaps the first fixed portion in the first direction.

10. The sensor according to claim 1, wherein
the first conductive layer further includes a first fixed portion region being continuous with the first conductive region,
a position of the first fixed portion in a third direction is between a position of the first fixed portion region in the third direction and a position of the first intermediate region in the third direction, and
the third direction crosses a plane including the first direction and the second direction.

11. The sensor according to claim 10, wherein
the first detection section further includes a first other fixed portion fixed to the first base region,
the first element is further supported by the first other fixed portion,
the first conductive layer further includes a first other fixed portion region being continuous with the first conductive region, and
a position of the first other fixed portion in the third direction is between the position of the first intermediate region in the third direction and a position of the first other fixed portion region in the third direction.

12. The sensor according to claim 7, further comprising:
a second detection section,
the base further including a second base region including a second intermediate region,
the second detection section including:
a second fixed portion fixed to the second base region, and
a second element supported by the second fixed portion,
the second element including a second resistance member,
the first conductive layer further including a second conductive region and a second other conductive region being continuous with the first conductive region and the first other conductive region,
a position of the second intermediate region in the second direction being between a position of the second conductive region in the second direction and a position of the second other conductive region in the second direction, and
a second gap being provided between the second intermediate region and the second element in the first direction.

13. The sensor according to claim 12, wherein
the controller is configured to output a value obtained by correcting a difference between a second electrical resistance of the second resistance member and the first electrical resistance using a value detected by the first temperature detection element.

14. The sensor according to claim 12, wherein
the first conductive layer further includes a second fixed portion region being continuous with the second conductive region,
a position of the second fixed portion in a third direction is between a position of the second fixed portion region in the third direction and a position of the second intermediate region in the third direction, and
the third direction crosses a plane including the first direction and the second direction.

15. The sensor according to claim 14, wherein
the second detection section further includes a second other fixed portion fixed to the second base region,
the second element is further supported by the second other fixed portion,
the first conductive layer further includes a second fixed portion region being continuous with the second conductive region, and
the position of the second other fixed portion in the third direction is between the position of the second intermediate region in the third direction and a position of the second other fixed portion region in the third direction.

16. The sensor according to claim 12, wherein
the controller includes a control element, and
the control element overlaps at least one of the first element or the first conductive layer in the first direction.

17. The sensor according to claim 16, wherein
the control element includes a CMOS (Complementary Metal Oxide Semiconductor).

18. The sensor according to claim 12, wherein
the second element further includes a second conductive member.

19. The sensor according to claim 1, wherein
the first conductive layer includes a first conductive film and a second conductive film,
at least a part of the second conductive film overlaps the first conductive film in the first direction,
the second conductive film is electrically connected to the first conductive film, and
a part of the base is provided between the first conductive film and the second conductive film.

20. The sensor according to claim 1, wherein
the first conductive layer includes a hole.
